(19) United States
(12) Patent Application Publication
(10) Pub. No.: US 2015/0039232 A1
(43) Pub. Date: Feb. 5, 2015

(54) Method of Correcting Mineral Ore Density Logs

(71) Applicant: Reeves Wireline Technologies Limited, Leicestershire (GB)

(72) Inventor: James Roger Samworth, Leicestershire (GB)

(21) Appl. No.: 14/449,528

(22) Filed: Aug. 1, 2014

(30) Foreign Application Priority Data
Aug. 1, 2013 (GB) 1313789.8

(51) Int. Cl. G01V 5/04; G01V 5/12; G01V 5/06

(52) U.S. Cl. CPC G01V 5/045; G01V 5/06; G01V 5/125
USPC 702/8

(57) ABSTRACT

A logging method includes carrying out respective density logs, using gamma detectors, along a length of borehole. The density log is corrected for the dimensions and properties of the borehole tubing, the method comprising correcting and combing the plurality of density logs obtained using a gamma ray source inside the tubing and relating to a length of well including the non-fixed tubing.

### BACKGROUND

The invention relates to a method of correcting one or more density logs of mineral ore bodies; and to apparatuses for carrying out such a method.

In the technical field of mineral production there are numerous important, technical reasons for identifying the nature of mineral ore bodies in or adjacent to a formation. It is generally considered desirable to acquire a good quality density log of a borehole in the vicinity of mineral ore bodies. Before completion of a borehole it is possible to obtain accurate density logs in open-hole. This is so even when there is mudcake in the borehole or the logging tool is “stood off” from the wall of the borehole. Under these circumstances it is possible to compensate the density log for example using one or more of the techniques disclosed in “The Dual-Spaced Density Log—Characteristics, Calibration and Compensation” —Samworth, The Log Analyst, February 1992.

When prospecting for minerals by drilling boreholes it is known to use liners made e.g. of polymeric or fibreglass materials to line the resulting bores. One purpose of such liners, which are sometimes referred to as “tubing”, is to provide a constant diameter along the length of the borehole; and another is to avoid problems such as caving-in of sections of the drilled cavity. Alternatively it is possible to leave the drill pipe used during forming of the borehole temporarily in place in the borehole for this purpose. The nature and characteristics of tubing and drill pipe will be familiar to the person of skill in the art.

In boreholes drilled for the purpose of extracting fluids such as oil, gas or water from under the ground or a sea bed, completion of the borehole involves the insertion of casing, which is a series of hollow metal tubes that are joined end to end in the borehole and fixed in place using cement interposed between the exterior of the tubes and the interior of the borehole. Such casing of a borehole presents particular problems when it is desired to log the formation using an energy-emitting sonde and one or more receivers of returned energy that has travelled through the rock of the formation. Some techniques however, such as that disclosed in U.S. Pat. No. 7,328,106, have proved highly successful in compensating for the effects of casing. An aspect of the technique of U.S. Pat. No. 7,328,106 relies on the fact that the casing is fixed in position by the cement.

When lining boreholes in mineral ore bodies, however, engineers generally do not fix the polymeric/fibreglass liners in place, with the result that they tend to “float” (i.e. move in up-and-down and/or side-to-side directions) in the borehole. If the drill-pipe is being used for this purpose, it can move in a similar way.

Similar problems arise during creation of the boreholes. Thus logging difficulties arise when considering drill pipe and/or drill rods, that are also examples of non-fixed tubing that may be present in a borehole during e.g. borehole drilling operations. It may be required to produce density logs through drill pipe or drill rods. The method of the invention is useable regardless of the non-fixed tubing type.

### SUMMARY

Herein is provided a method of producing a corrected density log, in a borehole in a geological formation extending through or adjacent one or more mineral ore bodies, for the effects of non-fixed tubing in the borehole. The method can include correcting and combining a plurality of density logs obtained using a gamma ray source inside the tubing and relating to a length of well including the non-fixed tubing therein. More specifically, the method can include:
correcting each of the said plurality of density logs for the dimensions and properties of the tubing, the said density logs resulting from use of a plurality of density detectors corresponding in number to the number of density logs and the correcting utilising gamma logs;
combining the thus-corrected density logs to compensate for one or more regions between the tubing and the geological formation; and
yielding a resultant output.

Such a method may advantageously compensate for the effects of the tubing and any voids “behind” the tubing (i.e. between the tubing and the formation). Thus, the method can offer an improved technique for the non-fixed tubing measurement of the density of formations, specifically in mineral ore bodies.

In one embodiment, the mineral ore body is iron ore, although the method is applicable in other types of mineral ore body as well.

The gamma ray source can be Caesium-137, Cobalt-60, or another source.

The tubing can be or include a polymeric pipe, for example PVC pipe. The tubing may also be made of other materials such as fibreglass. Alternatively the tubing may be or include drill pipe and/or one or more drill rods. The drill pipe or rod if present can be made of a metal such as steel or aluminium.

Correcting each of the said plurality of density logs for the dimensions and properties of the tubing can include one or more of:
modelling the effect of the tubing using a modelling database; or
calibrating the logs using a tubing calibration database.
   These techniques are advantageously reliable.

Alternatively, correcting each of the said plurality of density logs for the dimensions and properties of the tubing may optionally include correcting the logs for effects of the tubing using an iterative downhole calibration technique that is database-independent. The iterative calibration technique may offer advantages in terms of computer processing power and response times.

Combining the thus-corrected density logs to compensate for one or more regions between the tubing and the geological formation can include approximating the integrated geometric factor (G) of the borehole/density detector combination to an exponential function of the density log penetration depth. There is a detailed description of this technique in the paper by Samworth mentioned hereinabove. The entirety of this paper is incorporated herein by reference.

Combining the thus-corrected density logs to compensate for one or more regions between the tubing and the geological formation can further include approximating the exponential function to linear form. There is a description of this technique in the aforementioned paper by Samworth.

As an alternative to modelling the effect of the tubing using a modelling database; and/or or calibrating the logs using a tubing calibration database, combining the thus-corrected density logs to compensate for one or more regions between the tubing and the geological formation may alternatively include approximating the integrated geometric factor (G) of the density measurement to a series of straight lines.

The various calibration techniques described above may lend themselves to computation by different computational methods. It is possible for the logging engineer to implement any of a variety of embodiments of such methods that are most appropriate to the prevailing circumstances.

The method can be carried out using a single tool. Such a tool may contain all of the logging devices necessary to carry out the various operations described herein.

By “compact” is meant a tool whose outside diameter is less than about 57 mm (i.e. 2% inches). Such a tool is capable of more easily accessing narrow and otherwise difficult boreholes, than a tool of conventional diameter (i.e. about 89 mm or 3½ inches or greater).

According to a further aspect there is provided a borehole logging tool and data processing apparatus combination comprising a density sonde secured in the tool, the density sonde including a caliper for urging the density sonde into contact with the interior surface of a casing string, the density sonde being operatively connectable to one or more programmable devices that are programmed to carry out various techniques described above.

### BRIEF DESCRIPTION OF THE DRAWINGS

There now follows a description of preferred embodiments of the invention, by way of non-limiting example, with reference being made to the accompanying drawings in which:

FIG. 1 is a schematic view of a wireline tool, according to an aspect of the invention, that is capable of carrying out the method of the invention;

FIG. 2 is a plot of the integrated geometric factor G, characteristic of fractional contribution to the density measurement, against penetration depth in a formation, that illustrates some principles underlying the invention; and

FIG. 3 is a spine and ribs plot derivable through use of the method of the invention.

### DETAILED DESCRIPTION

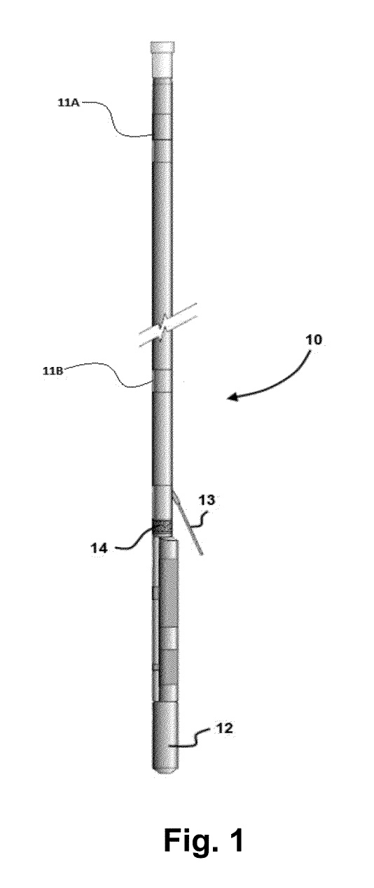

A method according to the invention involves the use of a logging tool 10 as shown in FIG. 1, that may be deployed in a borehole and subsequently used to log the borehole. A typical logging operation involves lowering, pumping or otherwise conveying the tool to the total depth of the borehole using one or more of the conveyance techniques described herein and/or as would be familiar to the person of skill in the art; and logging the borehole during withdrawal of the tool to the surface.

The electronics section of the tool may include one or more driver circuits capable of effecting telemetry of the logged data via a conventional, armoured wireline by means of which the tool is connected to a surface location.

As is well known in density logging, tools such as that shown in FIG. 1 produce so-called “short spaced” and “long spaced” logs using respective receivers (i.e. energy detectors) that are spaced relatively close to, and relatively far from, a gamma energy source.

Regardless of the precise method of conveying data to the surface location, the method of the invention involves the following actions:

1. Correcting each density log (i.e. the short and long spaced density logs) for the presence of the known dimensions and properties of the tubing. As noted herein this may be achieved through per se known modelling and/or calibration database techniques, or by iterative methods.
2. Combining the tubing-corrected logs in such a way as to compensate for the spaces between the tubing and the formation.

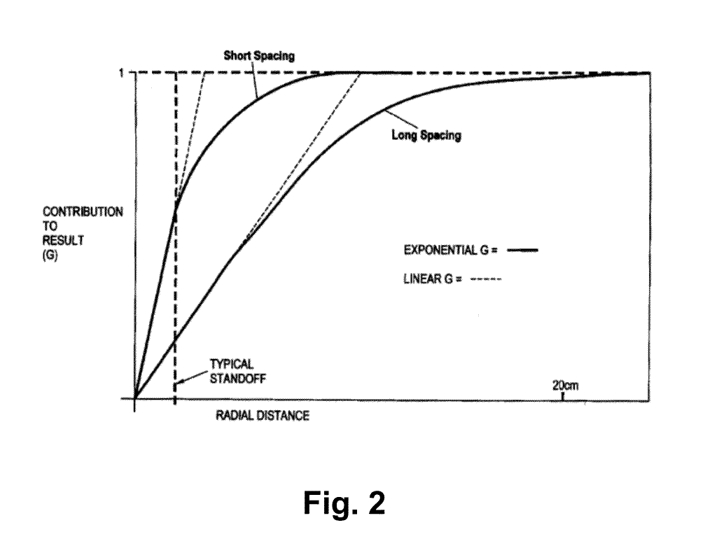

This is achieved by firstly approximating the integrated geometric factor (G) of the borehole/density detector combination to an exponential function of density measurement penetration depth, as illustrated by FIG. 2 which shows such an approximation in a plot of G against penetration distance measured radially from the gamma source.

G=1−e^{-kr} (1)

where

k=constant

r=penetration depth.

Now using geometric-factor theory and assuming that the tool stands off the borehole wall, the apparent measured density is given by:

ρₐ=Gₘρ_{mc}+G_{f}ρ_{f} (2)

where
ρ=apparent density
ρ_{mc}=mudcake or stood-off region density
ρ_{f}=formation density
Gₘ=mudcake or stood-off region integrated geometric factor
G _{f}=formation integrated geometric factor.

Since the analysis considers only a two-part situation, by definition of geometric factors:

Gₘ+G_{f}=1. (3)

Combining Equations 2 and 3 gives:

ρₐ=Gₘρ_{mc}+(1−Gₘ)ρ_{f}. (4)

Using the relationship in Equation 1 for G gives:

ρₐ=(1−e^{-kr})ρ_{mc}+e^{-kr}ρ_{f}. (5)

It is possible to estimate ρ_{mc}, but since r is unknown and variable, it is preferable to rearrange Equation 5 to eliminate it:

$$r = \frac{- 1}{k} {log}_{e} ( \frac{{ρ}_{a} - {ρ}_{mc}}{{ρ}_{f} - {ρ}_{mc}} ) . \qquad ( 6 )$$

This is true for both detectors, and if there exist parallel standoff conditions the r's are the same, thus:

$$\frac{1}{{k}_{L}} {log}_{e} ( \frac{{ρ}_{aL} - {ρ}_{mc}}{{ρ}_{f} - {ρ}_{mc}} ) = \frac{1}{{k}_{s}} {log}_{e} ( \frac{{ρ}_{aS} - {ρ}_{mc}}{{ρ}_{f} - {ρ}_{mc}} ) \qquad ( 7 )$$

where the suffices L and S refer to the long- and short- spaced detectors. When rearranged, this yields

ρ_{f}=(ρ_{aS}−ρ_{mc})^{[1/1-k}^{_{S}}^{/k}^{_{L}}^{)]}(ρ_{aL}−ρ_{mc})^{[1/1-k}^{_{L}}^{/k}^{_{S}}^{)]}+ρ_{mc}. (8)

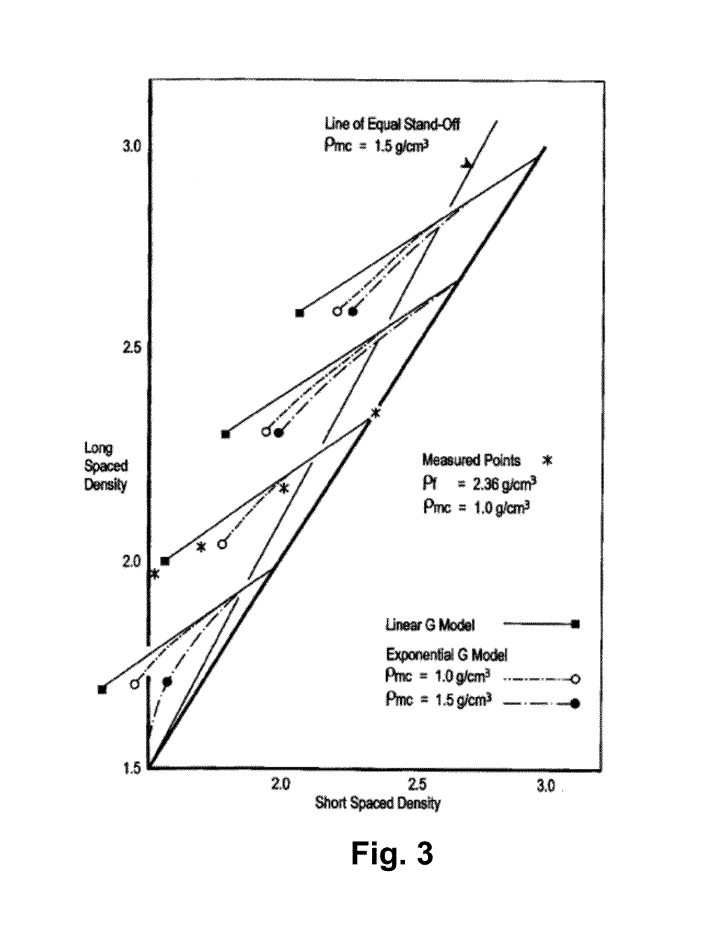

Note that the k's only appear as the ratio k_{S}/k_{L}. This means that only the ratio of the penetration depths is involved in Equation 8 (this can be derived from FIG. 3). To a first approximation then, the compensation remains valid even if the penetrations change, as long as their ratio stays constant.

Plotting Equation 8 gives a borehole-known “spine and ribs” plot as shown in FIG. 3 Although there is a need to estimate ρ_{mc}, it is apparent that for corrections up to 0.2-0.25 g/cc, the locus of the correction is very similar, even if ρ_{mc} varies markedly. The ribs rejoin the spine when ρ_{f}=ρ_{mc}. As a further refinement it is possible further to approximate the equation of “exponential-G” to linear form, as a further simplification.

The considerations of the standoff used only a two-part geometric-factor equation. Therefore, the form of G matters little for penetrations deeper than the standoff, since this appears solely as (1−G). Therefore, it is possible to consider a simpler form of G that should be reasonable for modest corrections (i.e., a linear form as in FIG. 3). For small penetrations and, therefore, small standoffs:

G=k′r (9)

where k′=constant. In this case, as in Equations 4 and 5

ρₐ=k′rρ_{mc}+(1−k′ᵣ)ρ_{f}. (10)

Rearranging as before,

$$r = \frac{1}{{k}^{′}} ( \frac{{ρ}_{a} - {ρ}_{f}}{{ρ}_{mc} - {ρ}_{f}} ) . \qquad ( 11 )$$

Eliminating r by using both detectors,

$$\frac{1}{{k}_{L}^{′}} ( \frac{{ρ}_{aL} - {ρ}_{f}}{{ρ}_{mc} - {ρ}_{f}} ) = \frac{1}{{k}_{s}^{′}} ( \frac{{ρ}_{aS} - {ρ}_{f}}{{ρ}_{mc} - ρ f} ) . \qquad ( 12 )$$

Rearranging and simplifying gives:

ρ_{f}=ρ_{aS}(1−k′_{S}/k′_{L})⁻¹+ρ_{aL}(1−k′_{L}/k′_{S})⁻¹. (13)

Note here that ρ_{mc} has cancelled out.

The spine-and-ribs plot for this linear G model also appears in FIG. 3. Again, the compensation locus varies little from the previous ones for modest corrections. Thus, the compensation is not a strong function of the form of G.

Referring now to FIG. 1 there is shown a wireline tool 10 that is, in conjunction with data processing apparatus to which it is connectable, capable of carrying out the method steps herein.

Tool 10 can be configured in two ways for use in air-filled or liquid-filled boreholes. In the air-filled borehole configuration the natural gamma detector is at the top of the tool, as exemplified by numeral 11A, so as to be remote from and not be influenced by the radioactive source at the bottom of the tool. In the fluid-filled borehole configuration the natural gamma detector is further down the tool e.g. at point 11B so as to minimise the length of unlogged hole at the bottom of the hole.

The gamma detector in each case therefore in effect is secured in series to a density sonde 13 including a per se known caliper mechanism (not shown) urging the sonde 13 into contact with the casing of the borehole; and a radiation source 12 that as is known to the person of skill in the art provides energy for the creation of log data.

Tool 10 includes per se known short and long spaced detectors.

Tool 10 may include a per se known cartridge (not shown in FIG. 1) containing an electronics section whose functions might include signal conditioning and amplification. However the primary means of obtaining useable data from the tool of FIG. 1 is by way of a per se known armoured wireline (not shown in FIG. 1), on an end of which the tool is driveable into a cased borehole. The wireline transmits electrical power to the tool 10 and permits data telemetry.

The tool 10 includes electronics whose function concerns the telemetry of logging data via the wireline to e.g. a surface location. At the surface location the wireline may connect to one or more programmed devices (such as a digital computer) that are capable of carrying out the method steps of the invention other than those carried out by the sondes.

The tool 10 preferably has a maximum diameter in the so-called “compact” or “slim-hole” range, i.e. less than about 57 mm (2¼ inches). However other, greater tool component diameters are possible within the scope of the invention.

The listing or discussion of an apparently prior-published document in this specification should not necessarily be taken as an acknowledgement that the document is part of the state of the art or is common general knowledge.

1. A method of producing a corrected density log, in a borehole in a geological formation extending through or adjacent one or more mineral ore bodies, for the effects of non-fixed tubing in the borehole, the method including correcting and combining a plurality of density logs obtained using a gamma ray source inside the tubing and relating to a length of well including the non-fixed tubing therein, the method comprising:
correcting each of the said plurality of density logs for the dimensions and properties of the tubing, the said density logs resulting from use of a plurality of density detectors corresponding in number to the number of density logs and the correcting utilising gamma logs;
combining the thus-corrected density logs to compensate for one or more regions between the tubing and the geological formation; and
yielding a resultant output.

2. A method according to claim 1 wherein the mineral ore body is iron ore.

3. A method according to claim 1 wherein the gamma ray source is Caesium-137.

4. A method according to claim 1 wherein the gamma ray source is Cobalt-60.

5. A method according to claim 1 wherein the tubing is or includes PVC or glass fibre pipe.

6. A method according to claim 1 wherein the tubing is or includes drill pipe and/or one or more drill rods.

7. A method according to claim 1 wherein correcting each of the said plurality of density logs for the dimensions and properties of the tubing includes one or more of:
modeling the effect of the casing using a modelling database; or
calibrating the logs using a casing calibration database.

8. A method according to claims 1 wherein correcting each of the said plurality of density logs for the dimensions and properties of the tubing includes correcting the logs for effects of tubing using an iterative downhole calibration technique that is database-independent.

9. A method according to claim 1 wherein combining the thus-corrected density logs to compensate for one or more regions between the tubing and the geological formation further comprises:
approximating the integrated geometric factor (G) of the borehole/density detector combination to an exponential function of density log penetration depth.

10. A method according to claim 9 further comprising:
further approximating the exponential function to linear form.

11. A method according to claim 1 wherein combining the thus-corrected density logs to compensate for one or more regions between the tubing and the geological formation further comprises:
approximating the integrated geometric factor (G) of the density measurement to a series of straight lines.

12. A method according to claim 1 when carried out using a single tool.

13. A borehole logging tool and data processing apparatus combination comprising density sonde, the density sonde including a caliper for urging the density sonde into contact with the interior surface of a casing string, the density sonde being operatively connectable to one or more programmable devices that are programmed to:
correct each of the said plurality of density logs for the dimensions and properties of the tubing, the said density logs resulting from use of a plurality of density detectors corresponding in number to the number of density logs and the correcting utilising gamma logs; and
combine the thus-corrected density logs to compensate for one or more regions between the tubing and the geological formation.

14. A borehole logging tool and data processing apparatus combination according to claim 13 wherein one or more of the programmable devices is programmed to:
yield a resultant output.
model the effect of the casing using a modeling database; or
calibrate the logs using a casing calibration database.
approximate the integrated geometric factor (G) of the borehole/density detector combination to an exponential function of density log penetration depth.
further approximate the exponential function to linear form.
approximate the integrated geometric factor (G) of the density measurement to a series of straight lines.

15. A borehole logging tool and data processing apparatus combination according to claim 13 including secured in the tool a Gamma detector for detecting natural Gamma radiation.

16. A borehole logging tool and data processing apparatus combination according to claim 14 including secured in the tool a Gamma detector for detecting natural Gamma radiation.

17. A borehole logging tool and data processing apparatus combination according to claim 13 having secured to the tool an armoured wireline on which the logging tool is supportable within a borehole tubing.

18. A borehole logging tool and data processing apparatus combination according to claim 14 having secured to the tool an armoured wireline on which the logging tool is supportable within a borehole tubing.

19. A borehole logging tool and data processing apparatus combination according to claim 13 wherein one or more of the programmable devices is remote from the logging tool and is operatively connected thereto by means of the wireline.

20. A borehole logging tool and data processing apparatus combination according to claim 14 wherein one or more of the programmable devices is remote from the logging tool and is operatively connected thereto by means of the wireline.
